(19) United States
(12) Patent Application Publication
(10) Pub. No.: US 2026/0087167 A1
(43) Pub. Date: Mar. 26, 2026

(54) SECURE FEDERATED LEARNING SYSTEM FOR HEALTHCARE DATA MANAGEMENT WITH PRIVACY PRESERVATION AND REGULATORY COMPLIANCE

(71) Applicant: Sabira Arefin, Boca Raton, FL (US)

(72) Inventor: Sabira Arefin, Boca Raton, FL (US)

(21) Appl. No.: 19/053,455

(22) Filed: Feb. 14, 2025

Related U.S. Application Data
(60) Provisional application No. 63/698,053, filed on Sep. 24, 2024.
(60) Provisional application No. 63/698,054, filed on Sep. 24, 2024.

(51) Int. Cl. G06F 21/62; G06F 21/55; G06N 20/00

(52) U.S. Cl. CPC G06F 21/6245; G06F 21/554; G06N 20/00; G06F 2221/034

(57) ABSTRACT

The invention introduces a system and method for secure healthcare data management using federated learning, advanced encryption, and compliance monitoring. The system enables healthcare institutions to train machine learning models locally on sensitive data without transferring raw information, ensuring privacy and regulatory compliance. Model updates are encrypted using robust cryptographic techniques, such as AES and RSA, and transmitted securely to a central aggregator. Privacy-preserving protocols, including secure aggregation and differential privacy, ensure confidentiality during the creation of a global model that integrates insights from multiple institutions. The global model is validated locally, ensuring contextual relevance and continuous improvement. The system also incorporates real-time compliance monitoring to automate adherence to standards like HIPAA and GDPR, with detailed logging and corrective actions. Modular architecture supports seamless integration with existing infrastructures and flexible deployment options. This invention offers a scalable, secure, and privacy-preserving framework tailored to the complex demands of healthcare data security.

### CROSS REFERENCE TO RELATED APPLICATIONS

This application claims benefit of U.S. Provisional Application Ser. No. 63/698,053 entitled “AI-Driven Predictive Threat Analysis and Anomaly Detection System for Healthcare Data Security”, filed Sep. 24, 2024, and U.S. Provisional Application Ser. No. 63/698,054 entitled “AI-Based Adaptive Encryption and Compliance Monitoring System for Securing Healthcare Data” filed Sep. 24, 2024, which is incorporated herein in its entirety.

### TECHNICAL FIELD

The field of this invention pertains to data security in healthcare environments, specifically to methods, systems, and computer-readable media for implementing privacy-preserving federated learning. This invention addresses the secure aggregation and utilization of distributed machine learning models while ensuring compliance with regulatory requirements, safeguarding sensitive patient data, and enabling collaborative threat detection among healthcare institutions. It is particularly applicable to environments involving electronic health records (EHRs), telemedicine platforms, and Internet of Medical Things (IoMT) devices.

### BACKGROUND OF THE INVENTION

The healthcare industry has undergone a transformative shift toward digitization in recent years, driven by the widespread adoption of electronic health records, telemedicine platforms, wearable health devices, and Internet of Medical Things systems. These advancements have significantly improved patient care, operational efficiency, and the ability to make data-driven decisions. However, the rapid adoption of these technologies has also introduced a multitude of challenges, particularly concerning data security and privacy. Sensitive healthcare data, including patient records, medical histories, diagnostic results, and billing information, is now more vulnerable than ever to sophisticated cyberattacks.

Healthcare organizations face an alarming rise in cyberattacks, including ransomware, phishing schemes, and advanced persistent threats. Cybercriminals target healthcare data because of its high value on the black market and its potential for misuse in identity theft, insurance fraud, and other criminal activities. Unlike financial data, which may lose its value after fraud detection, healthcare data often contains immutable and personal information, such as medical histories and genetic profiles, that cannot be easily changed. For instance, ransomware attacks have paralyzed hospitals, delaying critical care and compromising patient safety. Phishing scams have exploited unsuspecting employees to gain unauthorized access to sensitive databases. Advanced persistent threats have enabled attackers to infiltrate healthcare networks over extended periods, extracting valuable data undetected. The combination of these threats underscores the urgent need for robust and adaptive security mechanisms in the healthcare sector.

Traditional security measures such as firewalls, intrusion detection systems, and antivirus software rely heavily on static, rule-based mechanisms and predefined threat signatures. While these tools are effective against known attack vectors, they are ill-equipped to handle novel, adaptive threats. Moreover, traditional systems often operate in silos, leading to fragmented security architectures that fail to provide a comprehensive defense. The increasing interconnectedness of healthcare systems exacerbates these vulnerabilities. Internet of Medical Things devices, remote monitoring tools, and cloud-based healthcare solutions expand the attack surface, creating numerous entry points for attackers. These interconnected systems often lack standardization and security-by-design principles, making them susceptible to exploitation.

In addition to security challenges, healthcare organizations must navigate stringent regulatory frameworks that prioritize data privacy and compliance. Regulations such as the Health Insurance Portability and Accountability Act in the United States and the General Data Protection Regulation in Europe mandate strict guidelines for data protection, transparency, and accountability. Failure to comply with these regulations can result in severe financial penalties and reputational damage. Data sharing across healthcare institutions is often necessary for collaborative research, population health management, and the development of predictive analytics models. However, traditional data-sharing practices introduce significant privacy risks. For example, transferring raw data between organizations increases the likelihood of breaches and unauthorized access. These challenges highlight the need for privacy-preserving mechanisms that enable data sharing without compromising confidentiality.

Machine learning has emerged as a transformative tool in healthcare, enabling applications such as disease diagnosis, treatment optimization, predictive analytics, and operational efficiency improvements. However, training machine learning models often requires access to large, high-quality datasets. In traditional centralized approaches, data from multiple sources is aggregated into a single location for training, which introduces significant security and privacy risks. Centralized data aggregation not only increases the attack surface but also conflicts with regulatory requirements that mandate local data residency. Additionally, centralized systems are prone to single points of failure, making them less resilient to attacks and outages.

Federated learning offers a promising alternative to centralized machine learning by enabling decentralized training across multiple organizations. In a federated learning system, each participating organization trains a local machine learning model on its own data. Instead of sharing raw data, only model updates such as weights and gradients are transmitted to a central aggregator. The aggregator combines these updates to create a global model that reflects the collective knowledge of all participants. This decentralized approach addresses several key challenges. By keeping raw data local, federated learning minimizes privacy risks and ensures compliance with regulations. It can scale across diverse healthcare organizations, including hospitals, clinics, and research institutions. Decentralized systems are also less vulnerable to single points of failure, making them more robust against attacks.

Despite its advantages, federated learning presents unique technical challenges that must be addressed to make it viable in healthcare environments. Transmitting model updates to a central aggregator introduces privacy risks, as malicious actors could attempt to reconstruct sensitive data from the updates. Techniques such as secure aggregation and differential privacy are essential to mitigate these risks. Secure aggregation ensures that model updates are combined without exposing individual contributions, while differential privacy adds noise to the updates to prevent data reconstruction. Encrypting model updates before transmission is necessary to protect data in transit. However, encryption adds computational overhead, particularly when using advanced cryptographic schemes like homomorphic encryption or secure multiparty computation. Balancing security and efficiency is a critical consideration. The quality of the global model depends on the diversity and quality of the local data. In healthcare, data is often non-independently and identically distributed due to variations in patient demographics, diseases, and treatments across institutions. Ensuring that the global model performs well across diverse settings is a significant challenge. Federated learning systems involve frequent communication between participating organizations and the central aggregator. Efficient communication protocols are essential to minimize bandwidth usage and latency, particularly when dealing with large-scale deployments.

While federated learning provides a strong foundation for secure and privacy-preserving machine learning, a comprehensive system must address additional considerations specific to healthcare. These include adaptive security mechanisms that proactively detect and respond to emerging threats such as anomalous access patterns or compromised devices. Built-in compliance monitoring modules should ensure adherence to frameworks like HIPAA and GDPR. Integration with existing systems should allow seamless connectivity with electronic health record platforms, IoMT devices, and cloud-based solutions.

The present invention builds on the principles of federated learning to provide a robust, secure, and privacy-preserving system tailored to the needs of healthcare organizations. By integrating advanced technologies such as secure aggregation, differential privacy, and encryption, the invention addresses the limitations of traditional security mechanisms and the unique challenges of federated learning. The system is designed to protect sensitive patient data while enabling collaborative machine learning across institutions. It enhances threat detection through the use of a global model that analyzes activity data for anomalies indicative of unauthorized access or system misuse. The system simplifies compliance with regulatory requirements through automated monitoring and reporting tools. This invention represents a significant step forward in the field of healthcare data security, combining cutting-edge machine learning techniques with practical solutions for real-world challenges. By enabling secure and efficient collaboration among healthcare organizations, it lays the foundation for improved patient care, operational efficiency, and innovation in medical research.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

The invention provides a comprehensive system and method for enhancing healthcare data security through federated learning, advanced encryption, and compliance monitoring. It addresses critical challenges in safeguarding sensitive healthcare information while ensuring privacy, scalability, and regulatory compliance.

The invention enables healthcare institutions to train machine learning models locally using activity data stored within their systems. Local processors facilitate model training without transferring raw data outside the institution, preserving data privacy and aligning with regulations such as HIPAA and GDPR. Model updates, comprising weights and gradients, are encrypted using robust cryptographic techniques such as AES, RSA, or elliptic curve cryptography before being transmitted to a central aggregator. This encryption ensures secure transmission and protects sensitive information during the federated learning process.

At the central aggregator, the invention employs privacy-preserving protocols, including secure aggregation and differential privacy, to combine model updates from multiple institutions. These techniques prevent the reconstruction of raw data while ensuring the confidentiality of individual contributions. The aggregator generates a global machine learning model that integrates insights from all participating institutions. This model is distributed back to the institutions for deployment, enabling improved anomaly detection, risk prediction, and data analytics.

The global model is validated locally by each institution using representative datasets stored within their secure environment. The validation process ensures that the model performs effectively in diverse operational contexts while maintaining data privacy. Validation results inform further refinement and iterative training cycles, ensuring continuous improvement in model accuracy and reliability.

The invention also incorporates a compliance monitoring module to ensure adherence to regulatory standards. This module automates the monitoring of data access, storage, and transmission practices, generating audit-ready logs and triggering corrective actions when necessary. By integrating compliance monitoring with threat detection and encryption, the system provides a unified solution that reduces administrative burdens and enhances transparency.

Key hardware components, such as local processors, activity data storage, and encryption key storage, ensure secure and efficient operation at the institutional level. The aggregator processor, along with key management and aggregated model storage systems, facilitates centralized processing while maintaining data confidentiality. The system supports deployment in on-premises, cloud-based, or hybrid environments, offering flexibility to meet the needs of diverse organizations.

Through its modular architecture, advanced technologies, and privacy-preserving methods, the invention provides a scalable, adaptable, and secure framework for healthcare data management. The system's ability to protect sensitive information while enabling collaborative advancements in machine learning establishes it as a critical tool for modern healthcare organizations. By addressing security, compliance, and operational efficiency, the invention offers a robust solution to the growing complexities of data management in the healthcare sector.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1 depicts the system architecture for federated learning in healthcare, showing healthcare institutions (100A, 100B, 100N) with local processors (102) and data storage (104) transmitting encrypted model updates (106) to a central aggregator (110), which generates and distributes a global model (118).

FIG. 2 shows the federated learning process, including training local models (204), encrypting and transmitting updates (206), aggregating updates (208), generating a global model (210), and distributing it back to institutions (212).

FIG. 3 illustrates privacy-preserving aggregation, highlighting encrypted updates (300), secure aggregation (304), differential privacy (306), and global model generation (308).

FIG. 4 details the encryption process, showing local model updates (400), encryption (402), transmission through a secure channel (406), and optional decryption (410) at the central aggregator (408).

FIG. 5 depicts anomaly detection using the global model (500) with inputs such as user access logs (502) and network traffic (504), producing alerts for unauthorized access (510).

FIG. 6 represents hardware components, including local processors (600), activity data storage (602), encryption key storage (604), aggregator processor (606), key management (608), and aggregator model storage (610).

FIG. 7 shows validation of the global model (700) using local validation modules (704) and data storage (702), generating validation results (706).

FIG. 7 shows validation of the global model using local validation modules (804) and data storage (802), generating validation results (806).

The drawings described herein are for illustration purposes only and are not intended to limit the scope of the present subject matter in any way.

### DETAILED DESCRIPTION

The healthcare industry has embraced a wide range of digital innovations, including electronic health records, telemedicine, wearable devices, and cloud-based systems. These advancements have transformed patient care, operational workflows, and data-driven decision-making. However, the shift to interconnected and digitized ecosystems has introduced significant security challenges. Healthcare data, such as patient information, medical records, and diagnostic data, is not only sensitive but also highly valuable to cybercriminals. The sector has seen a surge in the frequency and sophistication of cyberattacks, such as ransomware, phishing, and advanced persistent threats, which jeopardize the confidentiality, integrity, and availability of critical data.

Traditional security solutions, such as firewalls, antivirus software, and intrusion detection systems, rely on static rule-based mechanisms or predefined threat signatures to detect and mitigate threats. While these methods are effective against known vulnerabilities, they are inadequate in countering adaptive, evolving, and novel attack vectors. The growing interconnectedness of healthcare systems, particularly through Internet of Medical Things (IoMT) devices, remote monitoring tools, and mobile applications, has expanded the potential attack surface, exposing these systems to a broader range of threats. Insider threats, both intentional and unintentional, further exacerbate the risks. Employees or authorized users may inadvertently expose sensitive data through misconfigurations, or they may abuse their access privileges, creating additional vulnerabilities within healthcare infrastructures.

A critical technical gap exists in the ability of healthcare systems to provide proactive, intelligent, and adaptive security mechanisms tailored to the specific needs of these environments. Conventional security systems often fail to analyze large volumes of real-time data or detect subtle anomalies that may indicate an emerging threat. These systems also lack integration across critical functions such as anomaly detection, encryption, and compliance monitoring, leading to fragmented security operations. Furthermore, traditional anomaly detection systems often generate an overwhelming number of false positives, which burden security personnel, contribute to alert fatigue, and delay responses to genuine threats. This deficiency underscores the need for advanced systems that can intelligently and efficiently mitigate risks without causing undue operational strain.

Compounding these issues are the stringent regulatory requirements imposed on healthcare organizations. Regulatory frameworks such as the Health Insurance Portability and Accountability Act (HIPAA) in the United States and the General Data Protection Regulation (GDPR) in Europe mandate comprehensive data protection, auditability, and transparency. However, achieving and maintaining compliance is resource-intensive, particularly in complex healthcare environments with legacy systems that lack real-time monitoring or automation capabilities. As these regulations evolve, organizations often struggle to keep pace, leaving critical security gaps unaddressed. Compliance failures can result in severe penalties, including financial fines and reputational damage, further emphasizing the need for integrated solutions.

Another pressing challenge is ensuring data privacy while facilitating the analysis required for operational efficiency and research. Traditional encryption methods, while essential for protecting sensitive data, are often static and resource-intensive. These methods fail to adapt to varying levels of data sensitivity or operational requirements, limiting their effectiveness in dynamic environments. Additionally, machine learning models in healthcare often rely on centralized datasets, which introduce risks of data breaches and privacy violations during transfer or aggregation. Addressing these technical gaps requires a holistic and intelligent approach that incorporates advanced technologies, such as artificial intelligence, federated learning, and adaptive encryption, to enable robust security while supporting the healthcare industry's evolving needs.

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments maybe utilized and that changes may be made without departing from the scope of the present invention. The following detailed description is, therefore, not to be taken in a limited sense, and the scope of the present invention is defined only by the appended claims.

The specification may refer to “an” “one” or “some” embodiment(s) in several locations. This does not necessarily imply that each such reference is to the same embodiment(s), or that the feature only applies to a single embodiment. A single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the foregoing sections, some features are grouped together in a single embodiment for streamlining the disclosure. This method of disclosure is not to be interpreted as reflecting an intention that the disclosed embodiments of the present disclosure must use more features than are expressly recited in each claim. Rather, as the following claims reflect, the inventive subject matter lies in less than all features of a single disclosed embodiment. Thus, the following claims are hereby incorporated into the detailed description, with each claim standing on its own as a separate embodiment.

The present invention offers a comprehensive solution to address the pressing security challenges faced by the healthcare industry. It introduces a multi-module, AI-driven system that seamlessly integrates advanced machine learning, adaptive encryption, and privacy-preserving techniques. This system is specifically designed to operate within the dynamic and highly regulated environments of healthcare organizations, ensuring the confidentiality, integrity, and availability of critical data. By proactively detecting threats, safeguarding sensitive information, and automating compliance monitoring, the invention provides a unified framework that significantly enhances the security posture of healthcare ecosystems.

At the core of the invention is a machine learning-based anomaly detection module that continuously monitors user behavior, system activities, and network interactions in real time. Unlike traditional systems that rely on static rules or signatures, this module leverages advanced algorithms to identify deviations from established behavioral baselines. The module is designed to detect unauthorized access, potential cyberattacks, and other security threats with high accuracy. It employs techniques such as clustering, time-series analysis, and autoencoders to analyze large volumes of real-time and historical data, ensuring that even subtle anomalies indicative of emerging threats are detected early. This proactive approach enables healthcare organizations to mitigate risks before they escalate into significant breaches.

The invention also includes an adaptive encryption module that dynamically applies encryption protocols based on the classification of data by sensitivity and access requirements. This module goes beyond traditional static encryption methods by employing advanced techniques such as homomorphic encryption, which allows computations to be performed directly on encrypted data without the need for decryption. This ensures that sensitive data remains protected even during processing. The adaptive nature of the module allows it to adjust encryption protocols in real time based on evolving threat landscapes and operational needs, balancing performance and security without disrupting workflows.

To address the privacy and scalability challenges of machine learning in healthcare, the invention incorporates federated learning as a core component. Federated learning enables decentralized training of machine learning models across multiple healthcare organizations without requiring the transfer of raw data. Instead, only model updates such as gradients or weights are transmitted to a central aggregator. This approach preserves data privacy, reduces the risk of breaches, and ensures compliance with regulatory frameworks. By allowing institutions to collaboratively improve their threat detection models without compromising data confidentiality, federated learning enhances both security and scalability across diverse healthcare environments.

The invention further includes a compliance monitoring module that automates adherence to regulatory requirements such as HIPAA and GDPR. This module continuously evaluates data access, storage, and transmission practices against regulatory standards, maintaining detailed logs of security events and generating audit-ready reports. In the event of a compliance violation, the module triggers corrective actions such as restricting access or notifying administrators. By integrating compliance monitoring with threat detection and encryption, the system not only simplifies regulatory adherence but also builds trust among patients, healthcare providers, and other stakeholders. Collectively, these features establish a robust, scalable, and privacy-preserving security framework tailored to the unique needs of healthcare organizations.

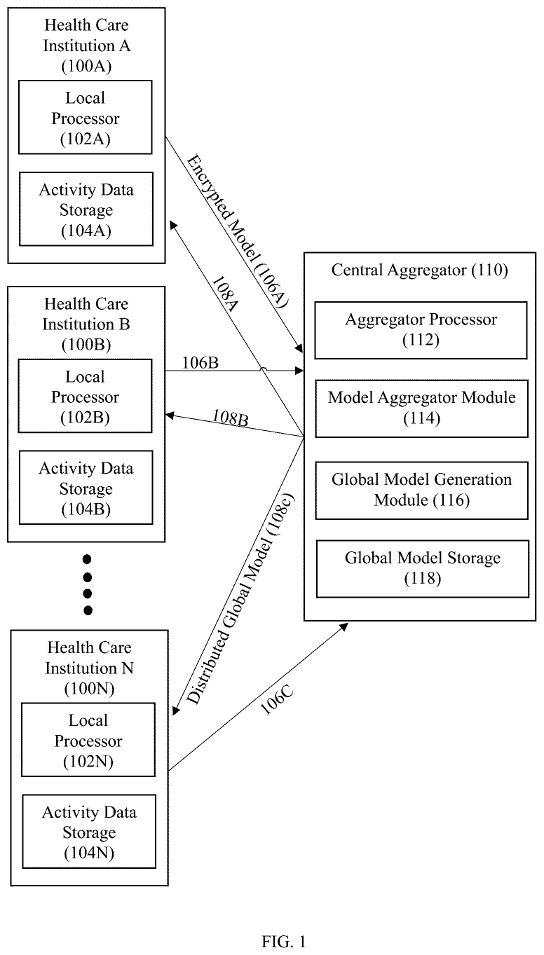

FIG. 1 illustrates the overall system architecture for implementing federated learning in healthcare data security. This architecture is designed to enable decentralized machine learning while preserving data privacy, ensuring compliance with regulatory standards, and mitigating the risk of data breaches. The figure depicts the interactions between multiple healthcare institutions, each equipped with its own local processing and storage systems, and a central aggregator that combines model updates to generate a global model. Each component of the system plays a critical role in achieving the intended functionality.

The architecture begins with healthcare institutions (labeled as 100A, 100B, and 100N), representing the diverse entities participating in federated learning. These institutions could include hospitals, clinics, research centers, or any other healthcare-related organizations. Each institution has a local processor (102A, 102B, 102N) responsible for training a local machine learning model on data stored within the institution. The activity data storage (104A, 104B, 104N) securely holds the institution's data, such as electronic health records, network logs, and system interaction data. By performing local training, the system ensures that raw data remains stored within the organization, minimizing privacy risks and complying with data residency requirements imposed by regulations like HIPAA and GDPR.

Once the local training is complete, each healthcare institution generates encrypted model updates (106), which represent the learned parameters (e.g., weights and gradients) of the local model. These updates are encrypted to ensure that no sensitive information is exposed during transmission. The encrypted updates are then securely transmitted to the central aggregator (110), which serves as the hub for combining updates from all participating institutions. This secure transmission is critical to prevent interception or tampering by malicious actors during the communication process.

The central aggregator consists of several key components, each with distinct roles. The aggregator processor (112) is responsible for processing the received model updates. It uses a model aggregation module (114) to combine these updates in a privacy-preserving manner. For instance, secure aggregation protocols ensure that individual updates are obscured while still allowing the global model to benefit from the collective knowledge of all participants. The aggregator may also apply differential privacy techniques to add noise to the aggregated updates, further protecting the confidentiality of the original data. Once aggregation is complete, the global model generation module (116) refines and updates the global machine learning model, incorporating the aggregated information to enhance its accuracy and robustness.

The final step in the process involves the distribution of the global model (118) back to the participating healthcare institutions. The global model contains insights derived from the collective datasets of all institutions without exposing individual datasets. This distribution enables each organization to leverage the improved global model for local anomaly detection, predictive analytics, or other machine learning applications while maintaining the privacy of their data. By repeating this cycle iteratively, the system continuously improves the global model over time, adapting to new patterns and emerging threats.

The system architecture emphasizes a modular approach to federated learning, specifically tailored for healthcare environments. Each institution trains local models using patient activity data stored securely within its infrastructure, ensuring compliance with data residency requirements. Model updates, comprising refined parameters, are encrypted and transmitted to a central aggregator. Privacy-preserving protocols, such as secure aggregation and differential privacy, are employed during the aggregation phase to prevent reconstruction of sensitive data. The global model, generated at the central aggregator, incorporates insights from all participating institutions and is securely redistributed for local deployment. This iterative process ensures continual refinement of the global model, adapting dynamically to emerging security threats.

Overall, FIG. 1 encapsulates a secure and scalable framework for federated learning in healthcare environments. It ensures that sensitive data remains local while enabling collaborative model training across multiple entities. The architecture is designed to balance privacy, performance, and compliance, addressing the unique challenges of the healthcare industry while providing a robust solution for enhancing data security and operational efficiency.

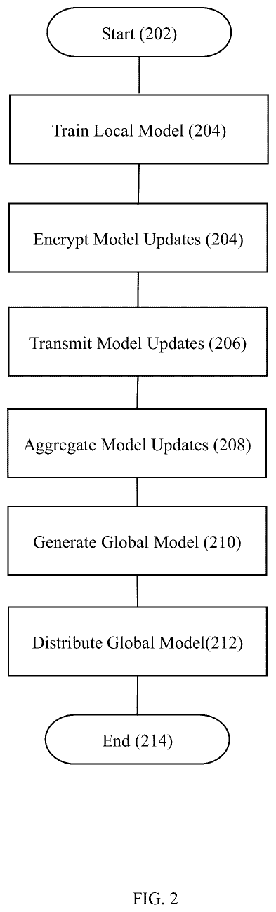

FIG. 2 presents the flowchart of the federated learning process in the context of healthcare data security. It outlines the sequential steps involved in training local models, securely transmitting model updates, aggregating updates at the central aggregator, and distributing the resulting global model. Each step in the flowchart corresponds to a critical stage of the federated learning cycle, ensuring that sensitive healthcare data remains secure while enabling collaborative model training across multiple institutions.

The process begins at 202, where the initialization step prepares local healthcare systems for model training. During this stage, activity data such as user access logs, network traffic patterns, and system interactions are pre-processed to ensure compatibility with the local machine learning models. The local processors at each healthcare institution then proceed to train their respective models at 204. This step ensures that training occurs locally, preventing raw data from leaving the secure confines of the institution, thereby preserving privacy and meeting regulatory requirements.

Following the training process, model updates are generated and encrypted at 206. These updates, comprising learned parameters such as weights and gradients, are secured using encryption protocols to protect against interception or tampering during transmission. Encryption is a crucial safeguard, ensuring the confidentiality of data even during its transfer to the central aggregator. The encrypted model updates are then transmitted securely at 208 to the central aggregator, which processes them for further aggregation.

At 210, the central aggregator receives encrypted model updates from multiple healthcare institutions. It combines these updates using privacy-preserving protocols such as secure aggregation or differential privacy. Secure aggregation ensures that the contributions from individual institutions cannot be reconstructed, maintaining the confidentiality of sensitive information. Differential privacy further enhances security by introducing noise into the aggregated updates, protecting against inference attacks. The aggregated updates are used to refine and generate a global machine learning model, incorporating the collective knowledge derived from all participating institutions.

The final step occurs at 212, where the global model is distributed back to the participating healthcare institutions. This global model benefits from the diverse data used during aggregation and can be deployed locally for enhanced anomaly detection, predictive analytics, and operational insights. The entire process then iterates, allowing institutions to continue training local models and contributing updates to the global system. This iterative approach ensures that the global model evolves over time, adapting to new data patterns and emerging security threats.

The invention employs an iterative training cycle for refining global models. Each participating institution validates the global model locally using representative datasets to ensure contextual relevance. Validation results are analyzed, and subsequent training iterations incorporate feedback to improve model accuracy and adaptability. This cyclical approach allows the global model to dynamically respond to emerging patterns and threats, maintaining its robustness across diverse healthcare environments.

FIG. 2 effectively captures the flow of federated learning and its emphasis on security and privacy at every stage. By referencing specific actions such as initialization at 202, training at 204, and aggregation at 210, the description provides a clear and structured understanding of how the system operates. This visualization highlights the robustness of the invention and its ability to address the unique challenges of data security and collaboration in healthcare environments.

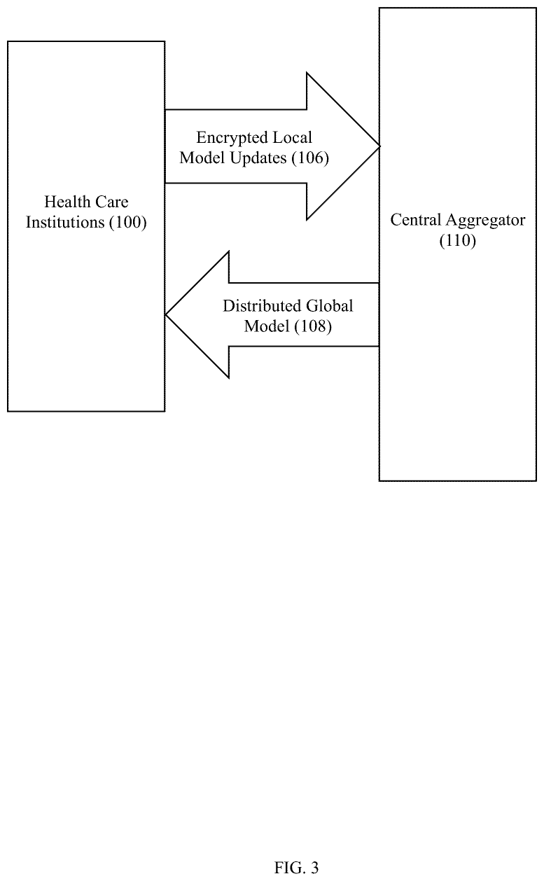

FIG. 3 depicts the privacy-preserving protocol utilized during the aggregation phase of the federated learning process. This process ensures that the sensitive data from multiple healthcare institutions, represented by 100, remains protected while contributing to the global model. The figure demonstrates how encrypted local model updates, represented by 106, are securely transmitted to the central aggregator, shown at 110, for aggregation and global model generation.

At 100, healthcare institutions prepare their encrypted local model updates based on the training performed on their local datasets. These updates, consisting of learned model parameters such as weights and gradients, are encrypted to ensure data confidentiality during transmission. The encryption prevents unauthorized access and ensures compliance with stringent privacy regulations such as HIPAA and GDPR. The encrypted updates are then transmitted securely to 110, where they are processed further.

The central aggregator at 110 receives encrypted updates from multiple healthcare institutions and uses privacy-preserving techniques to combine them into a unified representation. This ensures that while the global model benefits from the aggregated knowledge of all participating institutions, no individual institution's data is exposed or reconstructed. Secure aggregation techniques such as homomorphic encryption or secure multi-party computation can be applied at this stage to maintain data confidentiality.

The aggregated data is then used to generate a global machine learning model, which incorporates insights from the diverse datasets across all institutions. This global model, represented by 108, is redistributed to the participating healthcare institutions. The distributed global model allows each institution to enhance its local anomaly detection and predictive analytics capabilities while maintaining the privacy of its underlying data.

FIG. 3 provides a high-level visualization of the secure interaction between the healthcare institutions at 100 and the central aggregator at 110. The representation of encrypted local model updates as 106 and the distributed global model as 108 underscores the system's emphasis on secure data handling and collaborative model training. This process illustrates how the invention balances privacy, compliance, and performance in healthcare environments.

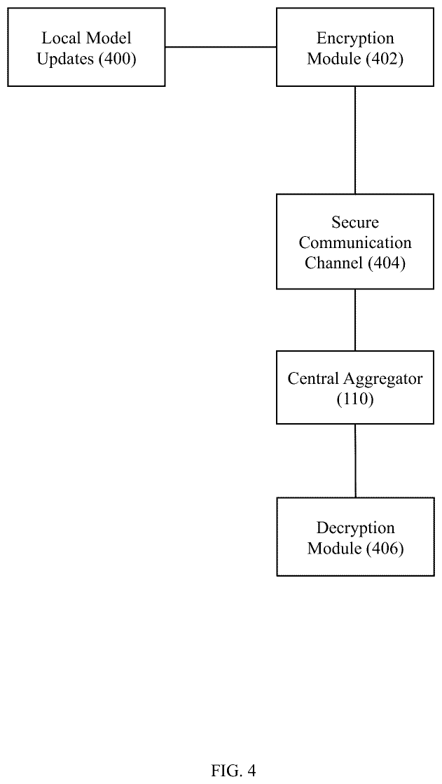

FIG. 4 illustrates the encryption process for securing local model updates before they are transmitted to the central aggregator. This process ensures the confidentiality of model updates during their journey over potentially vulnerable communication channels. The figure highlights the key components and flow of operations involved in the encryption and secure transmission of model updates.

The process begins with the generation of local model updates 400. These updates, consisting of trained model parameters such as weights and gradients, are produced by local processors after training on the institution's activity data. These updates are critical for contributing to the global machine learning model but must be protected from unauthorized access or tampering during transmission.

To safeguard the updates, they are passed through an encryption module 402. This module applies advanced cryptographic techniques, such as symmetric or asymmetric encryption, to ensure that the updates are rendered unreadable to unauthorized parties. By encrypting the updates at this stage, the system ensures data confidentiality and compliance with regulatory requirements such as HIPAA and GDPR. The choice of encryption protocol can be adapted based on the sensitivity of the data and the security policies of the healthcare institution.

Once encrypted, the updates are transmitted via a secure communication channel 404 to the central aggregator. This channel is designed to prevent interception or tampering of the encrypted updates during their transmission. Protocols such as Transport Layer Security (TLS) may be employed to enhance the security of the communication process. The secure channel forms a critical barrier against potential cyberattacks targeting data in transit.

To enhance security, the system employs multiple layers of advanced protocols. Differential privacy ensures that noise is introduced into aggregated model updates, preventing inference attacks and protecting individual contributions. Homomorphic encryption allows secure computations on encrypted data, eliminating the need for decryption during processing. Secure multi-party computation (SMPC) further fortifies privacy by enabling computations across decentralized datasets without exposing raw data. Additionally, Transport Layer Security (TLS) is utilized for encrypting communication channels, preventing unauthorized interception of data during transmission.

At the central aggregator, the encrypted updates are received and, if necessary, decrypted using a decryption module 406. This module reverses the encryption process, restoring the original model updates in a secure environment within the aggregator. Decryption ensures that the updates can be processed further for aggregation without compromising their confidentiality during earlier transmission stages.

The central aggregator, represented as 110, is the endpoint for securely transmitted updates. Once decrypted, the updates are combined with contributions from other healthcare institutions to generate a robust global model. The encryption process depicted in FIG. 4 is a cornerstone of the invention's privacy-preserving approach, ensuring that sensitive data remains protected throughout the federated learning process. By integrating robust encryption and secure transmission protocols, this system effectively mitigates the risk of data breaches and unauthorized access.

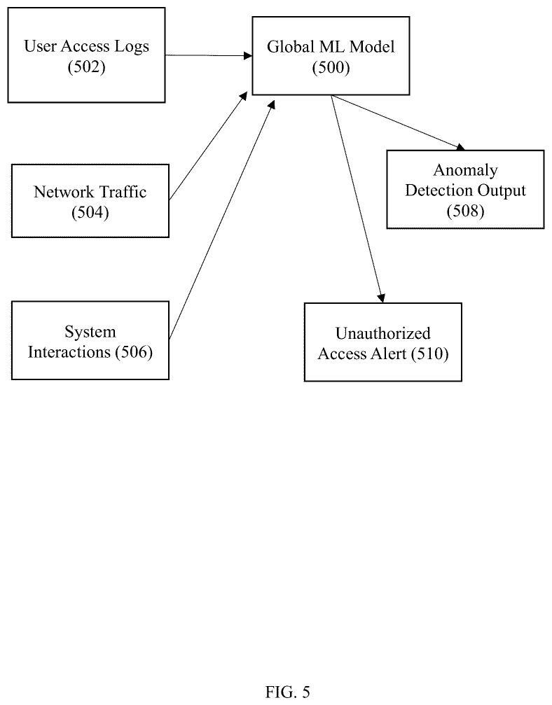

FIG. 5 depicts the anomaly detection process using the global machine learning model, showcasing how diverse inputs are processed to identify unauthorized access or misuse within a healthcare system. This figure highlights the integration of multiple data sources and the role of the global model in detecting and responding to anomalies.

At the center of the process is the global machine learning model, labeled 500, which has been trained using federated learning. This model encapsulates insights derived from the collective datasets of all participating healthcare institutions, enabling it to generalize across diverse environments. The global model is deployed locally at each institution to analyze various streams of activity data and identify potential threats.

The first input to the global model is user access logs, labeled 502. These logs provide detailed records of user authentication attempts, access patterns, and session activities within the healthcare system. By analyzing deviations from typical access behaviors, the global model can identify potential unauthorized access attempts or insider threats.

Another critical input is network traffic, labeled 504. This data captures information about the communication patterns within the healthcare infrastructure, including data exchanges between devices and external networks. Abnormalities in network traffic, such as unexpected spikes or connections to untrusted domains, are flagged by the global model as potential indicators of a security breach.

The third input is system interactions, labeled 506. This includes logs of interactions between users and the system, such as file access, application usage, and configuration changes. By analyzing these interactions, the global model can detect unusual activities that may signify misuse or exploitation of the system.

The outputs of the anomaly detection process are labeled as anomaly detection output at 508. These outputs indicate whether the observed behaviors deviate from the established baseline patterns. When anomalies are identified, they are classified by severity and context, allowing for targeted responses.

In cases of high-severity anomalies, the system generates an unauthorized access alert, labeled 510. This alert notifies security personnel or triggers automated responses, such as locking affected accounts or isolating compromised systems. The use of these outputs ensures that healthcare organizations can respond promptly and effectively to emerging threats.

FIG. 5 demonstrates the critical role of the global machine learning model in enhancing healthcare data security. By integrating inputs from user access logs, network traffic, and system interactions, the model provides a comprehensive analysis of potential threats. The anomaly detection outputs and alerts further emphasize the system's ability to safeguard sensitive healthcare data and maintain operational integrity.

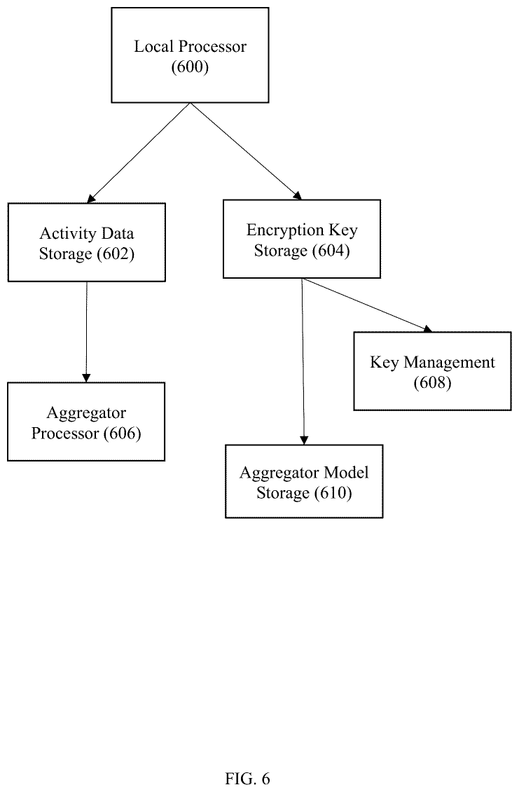

FIG. 6 depicts the hardware and system components required for implementing federated learning in healthcare data security. Each component plays a critical role in ensuring the confidentiality, integrity, and efficiency of the federated learning process, facilitating secure data handling, model training, and aggregation.

The local processor 600 is a key element at the healthcare institution level. This processor is responsible for training local machine learning models using activity data stored within the organization. The local processor ensures that all computations are performed locally, preserving the privacy of sensitive patient information and eliminating the need to transfer raw data outside the institution.

The activity data storage 602 securely holds datasets used for training the local machine learning models. This storage includes sensitive information such as electronic health records, user activity logs, system interactions, and network traffic. It ensures that data remains accessible for processing while being safeguarded against unauthorized access or tampering.

The system incorporates advanced hardware components to ensure secure and efficient operation. Each healthcare institution employs local processors to train machine learning models, while encryption key storage modules securely manage cryptographic keys used for encryption and decryption. At the central aggregator, processors perform privacy-preserving aggregation, ensuring sensitive data remains confidential. Role-based access control mechanisms are implemented to limit access to system components based on user roles, enhancing operational security. Hardware security modules (HSMs) are utilized for encryption key generation and management, mitigating risks associated with unauthorized access.

The system includes encryption key storage 604, which manages the cryptographic keys required for securing local model updates. These keys are essential for encrypting updates before they are transmitted to the central aggregator. Proper management of encryption keys is vital to maintaining the security of transmitted data and preventing unauthorized decryption.

At the central level, the aggregator processor 606 handles the aggregation of model updates received from multiple healthcare institutions. This processor applies privacy-preserving techniques, such as secure aggregation and differential privacy, to combine updates in a manner that protects the confidentiality of individual contributions. The aggregator processor ensures that the global machine learning model benefits from the collective insights of all participants without exposing sensitive information.

The key management module 608 is a central component that oversees the secure generation, storage, and rotation of encryption keys. It ensures that encryption keys are distributed securely and are periodically refreshed to mitigate the risk of compromise. By maintaining strict control over key management, the system safeguards the integrity and confidentiality of encrypted data.

The aggregator model storage 610 securely stores the global machine learning model generated by the central aggregator. This model integrates insights from all participating institutions, enabling advanced analytics and anomaly detection across diverse healthcare environments. The storage ensures that the model is protected from unauthorized access or tampering before being distributed to the participating institutions.

FIG. 6 illustrates the seamless integration of these components, providing a robust framework for federated learning. The depiction of local and central components, including processors, storage modules, and key management systems, emphasizes the invention's focus on security, privacy, and compliance with regulatory standards in healthcare environments.

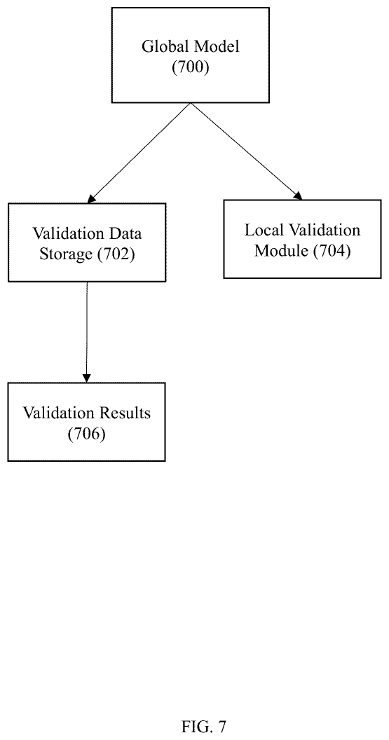

FIG. 7 illustrates the validation process of the global machine learning model within the federated learning framework. This figure highlights how the global model is evaluated using locally stored data at each healthcare institution, ensuring that the model performs effectively across diverse datasets while maintaining privacy.

The global model 700 represents the aggregated machine learning model generated by the central aggregator. This model incorporates knowledge derived from the collective datasets of all participating healthcare institutions. The global model is distributed to individual institutions to enable local validation and deployment.

Each institution stores its validation datasets in validation data storage 702. This storage contains representative samples of locally available data, such as user activity logs, network patterns, and system interactions. These datasets are crucial for evaluating the accuracy and robustness of the global model in the specific context of each institution. The local storage ensures that raw data does not leave the organization, maintaining compliance with privacy regulations.

The local validation module 704 is responsible for executing the validation process. This module uses the validation datasets stored in 702 to test the performance of the global model. The module runs a series of tests, including accuracy assessments, anomaly detection trials, and performance benchmarks, to determine how well the global model adapts to the institution's unique environment.

The outcomes of the validation process are recorded as validation results 706. These results provide detailed insights into the global model's performance, identifying strengths, weaknesses, and potential areas for improvement. Validation results are used to determine whether the global model meets the institution's operational requirements or needs further refinement in subsequent training cycles.

FIG. 7 showcases the decentralized evaluation process that allows each institution to independently verify the suitability of the global model. By leveraging local validation data and processes, the system ensures that the global model is robust, contextually relevant, and aligned with the unique needs of diverse healthcare organizations, all while safeguarding the privacy of sensitive data.

The system and method introduced in the invention revolve around federated learning for healthcare data security, ensuring privacy, scalability, and compliance. The invention begins by facilitating the local training of machine learning models at healthcare institutions. Local processors, such as 600 in FIG. 6, perform training using activity data stored in 602. This data includes user access logs, network traffic, and system interactions, ensuring that sensitive information remains securely within the institution. By training models locally, the system addresses regulatory requirements such as IPAA and GDPR, which emphasize data residency and privacy.

To protect the model updates during transmission, the invention includes an encryption module, as depicted in FIG. 4, referenced as 402. The encryption module employs robust cryptographic techniques, such as AES, RSA, and elliptic curve cryptography, to secure the updates before transmitting them to the central aggregator. This encryption ensures that even if the updates are intercepted during transmission via the secure communication channel 404, the sensitive information remains inaccessible to unauthorized entities. The secure transmission also aligns with the invention's objective to safeguard data at every stage of the federated learning process.

At the central aggregator, represented as 110 in FIG. 3, the system aggregates encrypted model updates using privacy-preserving protocols. The secure aggregation module, labeled 304 in FIG. 3, combines updates from multiple healthcare institutions in a way that prevents the reconstruction of raw data. Differential privacy, introduced at 306, further enhances security by adding noise to the aggregated updates. This ensures that individual contributions remain confidential, addressing potential risks of inference attacks. The aggregated updates are used to generate a global model, depicted as 308, which encapsulates the collective insights of all participating institutions without exposing their underlying datasets.

The global model, represented as 700 in FIG. 7, is distributed to participating institutions for deployment and validation. The validation process involves testing the global model using locally stored validation datasets, such as those held in 702. The local validation module, labeled 704, evaluates the model's performance on representative samples, ensuring it is accurate and contextually relevant to the institution's operations. Validation results, recorded as 706, provide feedback on the model's robustness and enable continuous refinement through iterative training cycles.

In addition to its robust data protection mechanisms, the invention includes compliance monitoring capabilities. The system evaluates data access, storage, and transmission practices against regulatory frameworks, such as HIPAA and GDPR. Detailed logs of security events and audit-ready reports simplify compliance while maintaining transparency. The system's compliance monitoring ensures that regulatory requirements are integrated seamlessly into its operations, reducing administrative burdens and building trust among stakeholders.

The compliance monitoring module is designed to ensure seamless adherence to regulatory frameworks such as HIPAA and GDPR. By automating compliance checks, the module continuously evaluates data access, storage, and transmission practices. It generates audit-ready reports and maintains detailed logs of security events for regulatory inspections. In case of violations, automated corrective actions are triggered, such as restricting access to compromised systems or notifying administrators. This integrated compliance monitoring approach enhances trust among stakeholders by combining regulatory adherence with robust encryption and proactive threat detection.

The invention also integrates key management modules, such as 604 and 608 in FIG. 6, to ensure the secure handling of cryptographic keys. These modules oversee the generation, distribution, and periodic rotation of keys, mitigating risks associated with key compromise. By integrating robust key management practices, the system ensures the confidentiality and integrity of encrypted data during transmission and storage.

In FIG. 5, the anomaly detection process is depicted using the global machine learning model labeled 500. This model processes inputs from user access logs 502, network traffic 504, and system interactions 506 to identify anomalies. Anomaly detection outputs, represented as 508, provide insights into potential threats, such as unauthorized access or system misuse. In high-severity cases, the system generates alerts, labeled 510, enabling prompt responses to mitigate risks.

By incorporating adaptive encryption, federated learning, privacy-preserving protocols, and compliance monitoring, the invention addresses the unique challenges of healthcare data security. It ensures that sensitive information is protected at every stage, from local model training and encrypted transmission to centralized aggregation and global model deployment. The invention enables secure collaboration among healthcare institutions, fostering innovation and efficiency while safeguarding patient trust.

The system architecture of the invention is composed of several interconnected components designed to collaboratively enhance the security of healthcare data. This architecture integrates advanced machine learning, dynamic encryption, federated learning, and compliance monitoring, forming a comprehensive, adaptable, and privacy-preserving framework. Each component works together to provide robust protection, improve operational efficiency, and ensure adherence to regulatory standards.

At the core of the system is the threat detection module, which serves as the foundation for proactive security measures. This module leverages machine learning algorithms to monitor user behavior, network traffic, and system activities in real time. Data is collected from multiple sources, such as electronic health records, network logs, and IoMT devices. The collected data is processed using clustering algorithms and autoencoders to establish baseline behavioral patterns. Any deviations from these patterns trigger alerts for potential unauthorized access or malicious activity. The module continuously learns from both historical and real-time data, adapting to new threats while minimizing false positives. By employing techniques such as time-series analysis to identify irregular access patterns and clustering algorithms to detect outliers, the system ensures timely identification and response to potential threats.

The adaptive encryption module is responsible for dynamically securing healthcare data. It categorizes data into sensitivity levels based on predefined policies and contextual factors, such as user roles, access permissions, and regulatory requirements. Encryption protocols, such as AES, RSA, or homomorphic encryption, are dynamically applied based on the sensitivity of the data. Homomorphic encryption enables computations to be performed on encrypted data without decryption, ensuring that sensitive information remains secure even during processing. The module continuously evaluates current threat levels and adjusts encryption methods in real time to balance performance and security. This dynamic approach ensures that data protection mechanisms align with evolving security landscapes.

The federated learning module enables decentralized training of machine learning models across multiple healthcare institutions. Each participating organization trains a local model on its own dataset, ensuring that raw data remains within the institution. Local model updates, such as weights and gradients, are securely transmitted to a central aggregator using privacy-preserving protocols, such as secure aggregation or differential privacy. The central aggregator combines these updates to refine the global model, which is then redistributed to participating organizations. This approach eliminates the need to transfer sensitive patient data, significantly reducing privacy risks while enabling collaborative advancements in anomaly detection and threat mitigation.

The compliance monitoring module ensures adherence to regulatory requirements, including HIPAA and GDPR. It continuously evaluates data access, storage, and transmission practices against regulatory standards. The module maintains detailed logs of security events and generates audit-ready reports to support regulatory inspections. When compliance violations are detected, the module triggers automated responses, such as notifications, access restrictions, or policy updates. This module operates in synergy with the threat detection and encryption components to ensure that all security measures align with regulatory mandates, reducing administrative burdens and enhancing transparency.

The system also includes a system integration interface to ensure seamless connectivity between the security system and existing healthcare infrastructures. This interface includes APIs to facilitate communication with electronic health record systems, telehealth platforms, IoMT devices, and cloud storage services. It supports various data formats and standards to enable smooth integration across diverse environments. The interface ensures that security operations, including encryption and anomaly detection, do not disrupt critical workflows, preserving the efficiency and reliability of healthcare systems.

The response management module executes predefined actions in response to detected threats or compliance violations. It classifies detected threats into severity levels, such as low, medium, or high, using a threat classification engine. Based on the severity, the module executes automated responses, such as locking user accounts, isolating affected systems, or alerting security personnel. Additionally, it provides contextual information and recommendations to aid in manual investigation and resolution of security incidents. By automating threat response, the system minimizes the impact of security events on healthcare operations.

The system's data flow begins with the collection of data from electronic health records, network logs, IoMT devices, and user activities. The threat detection module processes this data to identify anomalies, while the adaptive encryption module dynamically classifies and encrypts sensitive information. Federated learning enables training on decentralized datasets, with local model updates refined at the central aggregator to improve detection algorithms. The compliance monitoring module evaluates ongoing activities to ensure adherence to regulations, and the system generates alerts, reports, and corrective actions to address threats and maintain regulatory compliance. By integrating these components and processes, the architecture provides a scalable, intelligent, and privacy-preserving solution tailored to the unique challenges of healthcare data security.

The system is implemented using a combination of hardware, software, and networking technologies, ensuring compatibility with existing healthcare infrastructures and leveraging modern AI and cryptographic techniques. Each component in the system works collaboratively to provide robust security for healthcare data while maintaining scalability and compliance. The technical implementation is designed to align with the architecture and workflows depicted in the drawings.

The hardware requirements for the system are critical for supporting real-time processing, machine learning computations, and secure communication. Each healthcare institution employs a local processor, such as 600 in FIG. 6, which is responsible for training machine learning models locally. This ensures that sensitive patient data remains within the institution's secure environment. The local processor interacts with activity data storage, labeled 602, where datasets such as user access logs, system interactions, and network traffic are securely maintained. Encryption key storage, depicted as 604, manages cryptographic keys for encrypting model updates before transmission, ensuring data confidentiality during the federated learning process. The aggregator processor, represented as 606 in FIG. 6, performs secure aggregation and model generation, while key management, shown at 608, ensures the secure handling and periodic rotation of encryption keys.

The software architecture operates as a modular and scalable solution. Each module, such as those for anomaly detection, adaptive encryption, federated learning, and compliance monitoring, is implemented as an independent microservice. This modular design allows for flexibility and seamless integration. The system runs on a Linux-based operating system for its stability, security, and compatibility with AI frameworks and cryptographic libraries. AI frameworks such as TensorFlow or PyTorch are used to develop and train machine learning models, while encryption libraries such as PyCryptodome or OpenSSL handle the cryptographic requirements. For advanced techniques like homomorphic encryption, libraries such as HElib or Microsoft SEAL are utilized.

Databases play a key role in managing the storage of logs, model parameters, and configuration data. Structured data such as logs is stored in relational databases like PostgreSQL or MySQL, while unstructured or semi-structured data, such as JSON-formatted metadata, is stored in NoSQL databases like MongoDB. Regulatory compliance rules are encoded using configurable rule engines to enable real-time evaluation of data handling practices, ensuring adherence to frameworks like HIPAA and GDPR.

The machine learning model development process includes training anomaly detection models using historical data from healthcare systems. These models employ techniques such as time-series analysis and autoencoders to detect deviations in user access patterns. The federated learning process allows local training of models at each healthcare institution, ensuring that raw data remains local. Secure aggregation protocols and differential privacy, as depicted in FIG. 3 (304 and 306), ensure that updates are securely combined at the central aggregator without exposing individual contributions. The resulting global model, represented as 308, incorporates insights from all institutions and is redistributed for deployment and validation.

The network architecture ensures secure communication between system components. Transport Layer Security (TLS) encrypts all data exchanges, including the transmission of encrypted model updates (106 in FIG. 3) and the distribution of the global model (108 in FIG. 3). RESTful APIs facilitate seamless integration with external systems such as electronic health records, telehealth platforms, and IoMT devices. Firewalls and intrusion detection systems are configured to monitor and protect against external threats, ensuring the integrity of the network.

The system supports multiple deployment configurations to accommodate diverse operational needs. On-premises deployment is suitable for organizations with strict data residency requirements, while cloud-based deployment provides scalability and cost-efficiency. A hybrid approach combines on-premises data processing with cloud-based aggregation and compliance monitoring, providing flexibility and enhanced security. Each deployment option is designed to integrate seamlessly with existing workflows, as depicted in FIG. 6, where system components interact efficiently to process and secure data.

Workflow integration begins with data ingestion from sources such as EHRs, IoMT devices, and network logs. The threat detection module, shown as 500 in FIG. 5, processes these data streams to identify anomalies. The adaptive encryption module dynamically encrypts sensitive information based on data sensitivity, ensuring secure handling during processing and transmission. Federated learning enables local training and secure aggregation of model updates, while compliance monitoring ensures ongoing adherence to regulations. The response management module, as depicted in FIGS. 3 and 5, executes predefined actions in response to threats, such as alerting personnel or restricting access.

The system incorporates advanced security measures to safeguard against attacks. Role-based access control restricts access to system components based on user roles, ensuring that only authorized personnel can interact with sensitive data. Encryption keys are securely managed using hardware security modules (HSMs) or cloud-based key management services, depicted as 608 in FIG. 6. Redundancy and backup mechanisms ensure data integrity and availability, with failover systems in place to maintain operations during disruptions.

For example, consider a hospital deploying the system to secure its EHR and IoMT data. The threat detection module monitors network traffic and user activities, identifying anomalous login attempts from unexpected locations. The encryption module dynamically applies homomorphic encryption to EHR data, ensuring secure handling during processing. The federated learning module updates the anomaly detection model by aggregating updates from other hospitals, improving its accuracy while preserving privacy. The compliance monitoring module logs security events, generates reports, and alerts security personnel for further investigation, as shown in FIGS. 5 and 7.

The invention provides a robust framework for healthcare data security, offering several distinct advantages. By leveraging advanced technologies such as machine learning, adaptive encryption, and federated learning, the system addresses critical challenges in protecting sensitive patient information while ensuring compliance with regulatory requirements. The system incorporates proactive threat detection, dynamic encryption, and privacy-preserving machine learning to offer a comprehensive solution for modern healthcare organizations.

The system's proactive threat detection capabilities allow it to monitor and analyze user behaviors, network traffic, and system activities in real time. By utilizing machine learning models, the system can identify anomalies and predict potential security breaches before they occur. Unlike traditional rule-based security measures, this system adapts to emerging threats, reducing the likelihood of data breaches and ensuring timely responses to unauthorized access attempts.

Dynamic encryption is another significant advantage of the system, ensuring that sensitive healthcare data is protected at all times. The adaptive encryption module categorizes data based on sensitivity and applies appropriate encryption protocols, such as AES, RSA, or homomorphic encryption, to secure it. Homomorphic encryption allows computations to be performed on encrypted data without decryption, ensuring confidentiality even during data processing. This dynamic approach ensures that encryption aligns with the evolving threat landscape, balancing security and performance.

The system's federated learning module facilitates privacy-preserving collaboration across multiple healthcare institutions. By enabling decentralized training of machine learning models, the system ensures that raw patient data remains local while allowing organizations to collectively improve global model accuracy. Privacy-preserving techniques such as secure aggregation and differential privacy further enhance data security, ensuring that individual contributions are protected during model training and aggregation.

Regulatory compliance is seamlessly integrated into the system through the compliance monitoring module. This module automates adherence to standards like HIPAA and GDPR, continuously monitoring data access and storage practices to ensure compliance. By generating audit-ready logs and reports, the system reduces administrative burdens while enabling transparency. Automated responses to compliance violations, such as notifications or access restrictions, ensure that regulatory requirements are consistently met.

The modular architecture of the system supports seamless integration with existing healthcare infrastructures, including electronic health record platforms, IoMT devices, and cloud storage systems. APIs enable interoperability, allowing the system to enhance security without disrupting critical workflows. The flexibility of the system's deployment options, including on-premises, cloud-based, and hybrid configurations, ensures that organizations of varying sizes and technical capabilities can adopt the solution effectively.

The system is highly scalable and adaptable, making it suitable for a wide range of applications beyond healthcare. For example, it can secure telemedicine platforms by protecting real-time data exchanges during virtual consultations. Adaptive encryption ensures the confidentiality of audio, video, and medical records shared between patients and providers. Similarly, IoMT device security is enhanced through continuous monitoring and protection of sensitive data generated by devices such as heart rate monitors and insulin pumps.

The invention's capabilities also extend to collaborative healthcare research, where federated learning enables secure collaboration among hospitals, research institutions, and pharmaceutical companies. By preserving privacy and ensuring data security, the system facilitates advancements in medical research without exposing sensitive patient information.

The invention's applicability is not limited to healthcare. Its modular architecture and privacy-preserving techniques make it domain-agnostic, allowing it to be tailored to industries such as finance, education, and government. For instance, it can protect financial data by securing transaction logs and detecting fraudulent activities. In education, the system can safeguard student records while enabling decentralized training of AI models to improve educational tools. Similarly, it can enhance national security by securing classified information and ensuring compliance with regulatory standards.

The system's ability to protect privacy across sectors is enabled by advanced techniques such as homomorphic encryption and secure multi-party computation. These technologies address universal concerns about data confidentiality, allowing organizations in diverse fields to adopt the system without compromising security. Furthermore, the compliance monitoring module can be adapted to meet industry-specific regulations, ensuring relevance across various domains.

The invention's design is both forward-compatible and adaptable. It is not tied to specific programming languages, frameworks, or hardware architectures, making it accessible to organizations with diverse technological ecosystems. For instance, while TensorFlow or PyTorch are mentioned for implementing machine learning models, other frameworks like Keras or proprietary AI tools can also be used. Similarly, the system supports a range of hardware configurations, from high-performance GPUs to more modest setups, ensuring accessibility for organizations of varying sizes.

The integration of federated learning and advanced encryption methods ensures scalability and flexibility, allowing the system to address the challenges of emerging technologies such as IoT networks and cloud computing. Privacy-preserving techniques like differential privacy and secure aggregation provide additional layers of security, ensuring that sensitive data is protected during processing and collaboration.

By combining advanced machine learning, privacy-preserving technologies, and compliance automation, the system offers a versatile and comprehensive solution. Its ability to adapt to different industries, regulatory standards, and technological ecosystems ensures that it remains relevant and effective in addressing modern data security challenges. This forward-thinking approach positions the invention as a future-proof solution for organizations seeking to protect sensitive data while maintaining operational efficiency and regulatory compliance.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A method for federated learning in healthcare data security, comprising:
training, by at least one processor at a first healthcare institution, a local machine learning model on activity data stored within the institution, wherein raw data remains stored locally;
transmitting, by the at least one processor, model updates derived from the local machine learning model to a central aggregator;
aggregating, by at least one aggregator processor at the central aggregator, the model updates received from a plurality of healthcare institutions using a privacy-preserving protocol;
generating, by the aggregator processor, a global machine learning model based on the aggregated model updates; and
distributing, by the aggregator processor, the global machine learning model to the plurality of healthcare institutions.

2. The method of claim 1, wherein the privacy-preserving protocol comprises secure aggregation to prevent reconstruction of raw data from the transmitted model updates.

3. The method of claim 1, wherein differential privacy is applied to the model updates during the aggregating step.

4. The method of claim 1, further comprising encrypting the model updates prior to transmission to the central aggregator using a symmetric or asymmetric encryption scheme.

5. The method of claim 4, wherein the encryption scheme is selected from the group consisting of Advanced Encryption Standard, Rivest-Shamir-Adleman, elliptic curve cryptography, and combinations thereof.

6. The method of claim 1, wherein the global machine learning model is configured to detect anomalies in healthcare data access patterns.

7. The method of claim 6, wherein the anomalies detected by the global machine learning model are indicative of unauthorized access attempts or system misuse.

8. The method of claim 1, wherein the local machine learning model is trained using activity data comprising user access logs, network traffic, and system interactions.

9. The method of claim 1, further comprising evaluating the global machine learning model at each healthcare institution using locally stored validation data.

10. A system for federated learning in healthcare data security, comprising:
a first processor at a first healthcare institution configured to:
train a local machine learning model on locally stored activity data while retaining raw data within the institution, and
transmit model updates derived from the local machine learning model to a central aggregator; and
a central aggregator comprising at least one aggregator processor configured to:
aggregate model updates received from a plurality of healthcare institutions using a privacy-preserving protocol,
generate a global machine learning model based on the aggregated model updates, and
distribute the global machine learning model to the plurality of healthcare institutions.

11. The system of claim 10, wherein the privacy-preserving protocol comprises secure aggregation to prevent reconstruction of raw data from the transmitted model updates.

12. The system of claim 10, wherein differential privacy is applied by the aggregator processor to the model updates during aggregation.

13. The system of claim 10, wherein the first processor is configured to encrypt the model updates prior to transmission using a scheme selected from the group consisting of Advanced Encryption Standard, Rivest-Shamir-Adleman, elliptic curve cryptography, and combinations thereof.

14. The system of claim 10, wherein the global machine learning model is configured to detect anomalies in healthcare data access patterns.

15. The system of claim 14, wherein the anomalies detected by the global machine learning model are indicative of unauthorized access attempts or system misuse.

16. The system of claim 10, further comprising a memory operatively coupled to the first processor, wherein the memory stores training data, model parameters, and encryption keys.

17. The system of claim 10, wherein the local machine learning model is trained using user access logs, network traffic, and system interactions.

18. The system of claim 10, wherein the aggregator processor redistributes the global machine learning model to the plurality of healthcare institutions via an encrypted communication channel.

19. A non-transitory computer-readable medium storing instructions that, when executed by at least one processor, cause the processor to:
train a local machine learning model on activity data stored within a healthcare institution, wherein raw data remains stored locally;
transmit model updates derived from the local machine learning model to a central aggregator;
aggregate, at the central aggregator, model updates received from a plurality of healthcare institutions using a privacy-preserving protocol;
generate a global machine learning model based on the aggregated model updates; and
distribute the global machine learning model to the plurality of healthcare institutions.

20. The non-transitory computer-readable medium of claim 19, wherein the instructions further cause the processor to encrypt the model updates using a scheme selected from the group consisting of Advanced Encryption Standard, Rivest-Shamir-Adleman, elliptic curve cryptography, and combinations thereof prior to transmission.
